(19) United States
(12) Patent Application Publication
(10) Pub. No.: US 2008/0074239 A1
(43) Pub. Date: Mar. 27, 2008

(54) Electronic Tag, a Reader, and a Method for Manufacturing the Same

(76) Inventor: Mitsuo Usami, Tachikawa (JP)

Correspondence Address: REED SMITH LLP, 3110 FAIRVIEW PARK DRIVE, SUITE 1400, FALLS CHURCH, VA, 22042, US

(21) Appl. No.: 11/630,861

(22) PCT Filed: Aug. 4, 2004
(86) PCT No.: PCT/JP04/11490

§ 371 Date: Dec. 26, 2006

(51) Int. Cl. H04Q 5/22

(52) U.S. Cl. 340/10.4; 340/10.1; 340/572.1; 714/758

(57) ABSTRACT

A reader reads electronic tag data and a CRC code from an electronic tag and detects whether the electronic tag data has been received correctly, by using the CRC code. The CRC code is generated from reader data and electronic tag data stored in the reader and an error detection is performed by using the reader data, so that the error detection is performed simultaneously, and it is possible to selectively read out only the electronic tag data from the electronic tag correlated with the reader data.

### TECHNICAL FIELD

The present invention relates to an electronic tag, a reader, and a method for manufacturing the same, and particularly relates to a method for producing an error detection code of electronic tag data transmitted from an electronic tag to a reader.

### BACKGROUND ART

Conventionally, in a case where digital information is transmitted by a digital radio transmission system, cyclic codes such as a hamming code, a CRC code, a fire code, a BCH code and a Reed-Solomon code are used because they can be handled easily. Here, such codes are collectively called as the error detection code.

The CRC (Cyclic Redundancy Check) code which is one of the error detection codes also described in Japanese Patent Laid-Open Publication No. Hei 6-29864 is generally recommended by ITU-T (Telecommunication Standardization Sector of the International Telecommunications Union). Recently, FCS of RFC1662 has also become common according to the recommendation by the ITU-T because the Internet has become common.

For the CRC, a (n−1)th polynomial equation P(x) is expressed by (Equation 1) with an information bit determined as n bit of p₁˜pₙ.

$$\begin{matrix}P ( x ) = {\sum }_{i = 1}^{n} {p}_{i} {x}^{i - 1} \\ = {p}_{n} {x}^{n - 1} + {p}_{n - 1} {x}^{n - 2} + … + {p}_{3} {x}^{2} + {p}_{2} x + {p}_{1}\end{matrix} \qquad ( Equation 1 )$$

And, a (c−1)th polynomial equation generated is expressed by (Equation 2).

$$\begin{matrix}G ( x ) = {\sum }_{i = 1}^{c} {g}_{i} {x}^{i - 1} \\ = {g}_{c} {x}^{c - 1} + {g}_{c - 1} {x}^{c - 2} + … + {g}_{3} {x}^{2} + {g}_{2} x + {g}_{1}\end{matrix} \qquad ( Equation 2 )$$

The CRC code is provided by k bits (k=c−2) of coefficients r₁˜rₖ of remainder polynomial equation R(x) of (Equation 3) obtained by dividing the product, which is obtained by multiplying P(x) with a highest-order term x^{c-1} of a generated polynomial equation G(x), by Q(x).

$$\begin{matrix}R ( x ) = \frac{P ( x ) \cdot {x}^{c - 1}}{G ( x )} \\ = {\sum }_{i = 1}^{k} {r}_{i} {x}^{i - 1} \\ = {r}_{k} {x}^{k - 1} + {r}_{k - 1} {x}^{k - 2} + … + {r}_{3} {x}^{2} + {r}_{2} x + {r}_{1}\end{matrix} \qquad ( Equation 3 )$$

A transmitting side transmits the CRC code in a state added to the information bit. A receiving side judges that information bits p₁˜pₙ which are configured of n bits have been transmitted properly when E(x) expressed by (Equation 4) is dividable by the generated polynomial equation G(x), in which s₁˜sₙ denote received bits for the information bits p₁˜pₙ and t₁˜tₖ denote received bits for the CRC codes r₁˜rₖ.

$$\begin{matrix}E ( x ) = \{ ( {\sum }_{i = 1}^{n} {s}_{i} {x}^{i - 1} ) \cdot {x}^{c - 1} + {\sum }_{i = 1}^{k} {t}_{i} {x}^{i - 1} \} / G ( x ) \\ = ( S ( x ) \cdot {x}^{c - 1} + T ( x ) ) / G ( x )\end{matrix} \qquad ( Equation 4 )$$

The generated polynomial equation has an international standard for each bit count of the CRC code, and an equation such as X¹⁶+X¹²+X⁵+1 is used when the CRC code is 16 bits. When explained by a simplified example, an initial polynomial equation is determined as X³+X²+1, and a generated polynomial equation is determined as X²+1, so that the CRC code becomes X+1 which is its quotient.

The electronic tag stores an electronic tag number such as an identification number or the like and sends the electronic tag number together with an error detection code to a reader. It is practically required that the reader detects an error according to the received error detection code in order to detect an error in the received electronic tag data of the electronic tag.

And, the electronic tag is an electronic tag used attached to a variety of goods. It is largely advantageous practically to make it possible to selectively read only electronic tag data of an electronic tag attached to particular goods among the electronic tags attached to the variety of goods.

Under the circumstances described above, the invention performs error correction processing according to the error detection code, and selectively reads only electronic tag data of a particular electronic tag.

### DISCLOSURE OF THE INVENTION

(Solving Means)

Among the inventions disclosed by the present application, a typical one is described briefly below.

A reader reads electronic tag data and a CRC code from an electronic tag in which they are stored, and uses the CRC code and the reader data stored in the reader to perform error detection to see whether the electronic tag data has been received properly. The CRC code is generated from the electronic tag data and the reader data, so that when the reader receives electronic tag data of the electronic tag, the error detection of the electronic tag data and selection of the electronic tag data associated with the reader data can be performed by single processing.

### BRIEF DESCRIPTION OF THE DRAWINGS

FIG. 1 is a diagram showing an electronic tag system.

FIG. 2 is a diagram showing a logical data structure of electronic tag data and CRC code stored in the memory of an electronic tag.

FIG. 3 shows a logical data structure of reader data and generated polynomial equation data stored in the memory of a reader.

FIG. 4 is a flow chart showing a first embodiment of a process of reading electronic tag data from an electronic tag by a reader.

FIG. 5 is a diagram showing a first embodiment of a hardware configuration of an error detection portion.

FIG. 6 is a flow chart showing a second embodiment of the process of reading electronic tag data from the electronic tag by the reader.

FIG. 7 is a diagram showing a second embodiment of the hardware configuration of the error detection portion.

FIG. 8 is a diagram showing coexistence of electronic tag systems having a reader which stores different reader data.

FIG. 9 is a diagram showing a process of allocating electronic tag data and a CRC code to an electronic tag and a reader number and generated polynomial equation data to a reader.

FIG. 10 is a diagram showing a data structure stored in a management system.

FIG. 11 is a diagram showing a flow chart to generate a CRC code performed by a processing portion of the management system.

FIG. 12 is a diagram showing a hardware configuration of an encoding portion for generating a CRC code.

### BEST MODE FOR CARRYING OUT THE INVENTION

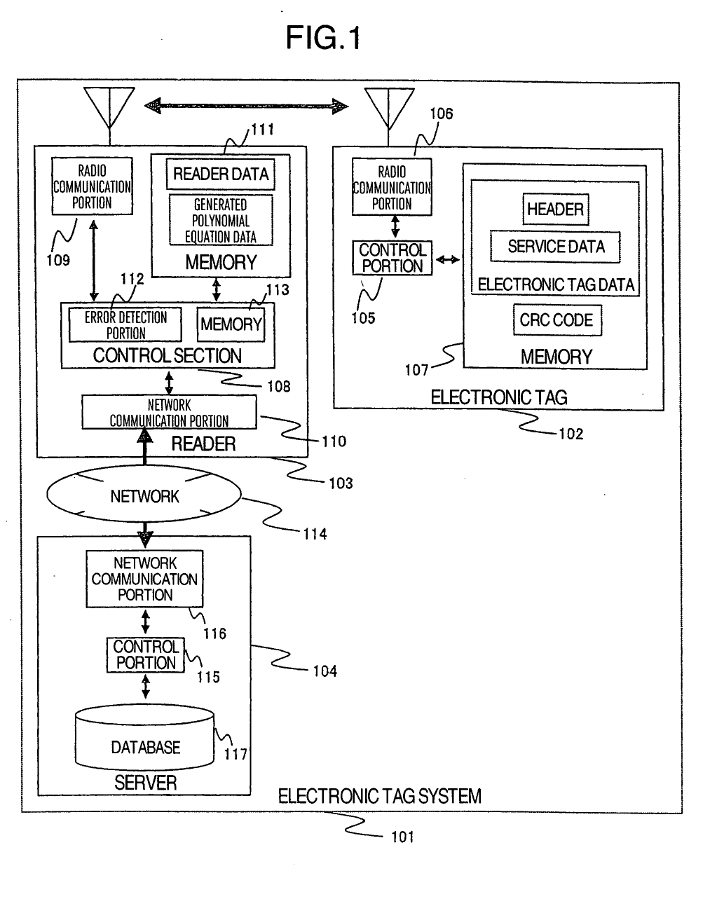

FIG. 1 shows an electronic tag system (101). The electronic tag system (101) has a server (104), a reader (110), and an electronic tag (102).

The server (104) is comprised of a database (DB) (117) for storing information associated with electronic tag data of the electronic tag, a network communication portion (110) for communicating with the reader through a network (114), and a control portion (115) for controlling the database and the network communication portion.

The reader is comprised of the network communication portion (110) for communicating with the reader through the network, a radio communication portion (109) for reading electronic tag data and CRC code from the electronic tag, a memory (111) for storing reader data and the generated polynomial equation data corresponding to coefficients of a prescribed generated polynomial equation, and a control section (108) for controlling the network communication portion and the radio communication portion. The control section has a memory for storing the electronic tag data and CRC code read from the electronic tag, and an error detection portion (112) for performing error detection of the received electronic tag data. And, the control section (108), the radio communication portion (109) and the memory (111) of the reader may be made of a single or plural IC chips. In a case where the error detection portion (112) is configured of hardware, the generated polynomial equation data is not stored in the memory but realized as wire connection or the like in the hardware.

The electronic tag has a radio communication portion (106) for transmitting electronic tag data and a CRC code to the reader, a memory (107) for storing the electronic tag data and the CRC code, and a control portion (105) for controlling the radio communication portion and the memory. The electronic tag data comprises a header which is information indicating the start of electronic tag data, and service data such as identification number or the like.

From the viewpoint of reduction of a circuit scale, it is desirable to use a ROM for the memory (107) of the electronic tag and the memory (111) of the reader. And, the control portion (105), the radio communication portion (106) and the memory (107) of the electronic tag can be made of a single or plural IC chips.

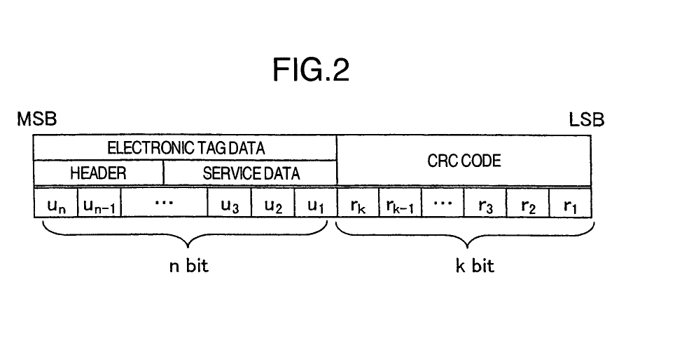

FIG. 2 shows a logical data structure of electronic tag data and CRC code stored in the memory of the electronic tag formed of the header and the service data. Electronic tag data uₙ˜u₁ of n bits formed of the header and the service data and CRC codes rₖ˜r₁ of k bits are arranged sequentially. The header and the electronic tag data configuring the electronic tag data are arranged sequentially in order of the header and the electronic tag data from the most significant bit (MSB) to the least significant bit (MSB).

The data structure of the electronic tag data is arbitrary and not limited to this embodiment. The arrangement may be made in order of the CRC code, the electronic tag data uₙ˜u₁, and the CRC codes rₖ˜r₁ from the most significant bit (MSB) toward the least significant bit (LSB). The data structure of the header and the service data configuring the electronic tag data is also arbitrary, and the arrangement may be made in order of the service data and the header from the most significant bit (MSB) toward the least significant bit (LSB). If necessary, another code may be included in the electronic tag data in addition to the header and the service data.

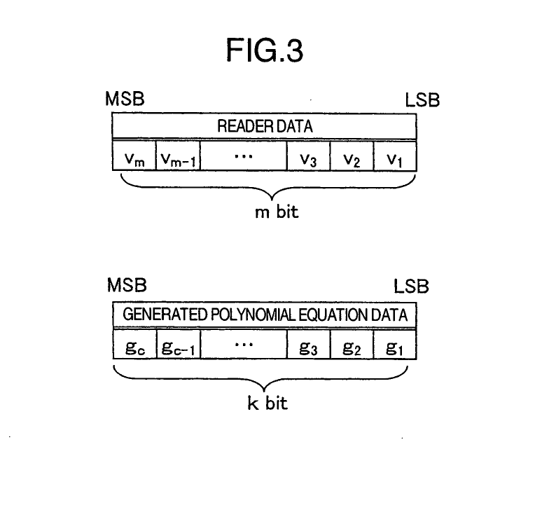

FIG. 3 shows a logical data structure of reader data and generated polynomial equation data stored in the memory of the reader. Reader data vₘ˜v₁ of m bits and generated polynomial equation data g_{c}˜g₁ of k bits are arranged in this order from the most significant bit (MSB) toward the least significant bit (LSB).

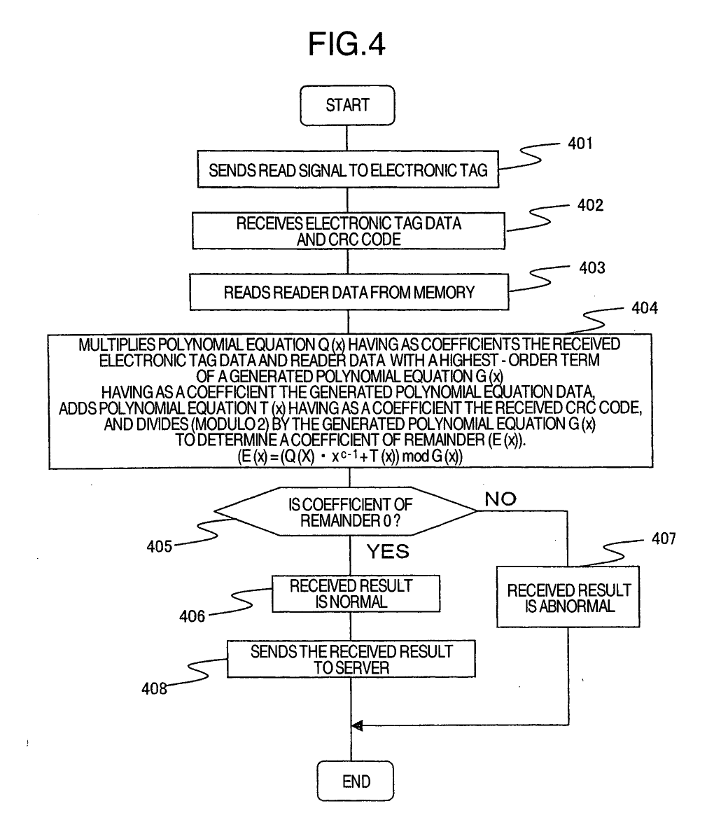

FIG. 4 shows a flow chart indicating a process of reading electronic tag data from an electronic tag by a reader.

First, the control section of the reader transmits a read signal to the electronic tag via the radio communication portion (401). The control portion of the electronic tag receives the read signal via the radio communication portion and sends back the electronic tag data and CRC code stored in the memory to the electronic tag. The control section of the reader reads the electronic tag data and CRC code via the radio communication portion (402). Upon reading the electronic tag data and CRC code, the control section of the reader reads reader data from the memory (403).

Here, the error detection portion in the control section of the reader multiplies a polynomial equation Q(x) having as coefficients the individual bits of the received electronic tag data and reader data according to received electronic tag data sₙ˜s₁ read from the electronic tag corresponding to electronic tag data vₙ˜v₁ of the electronic tag and reader data vₘ˜v₁ with a highest-order term x^{c-1} of a generated polynomial equation G(x) having as coefficients the individual bits of the generated polynomial equation data, adds polynomial equation T(x) having as coefficients the received CRC code data tₖ˜t₁ read from the electronic tag corresponding to the CRC codes rₖ˜r₁ of the electronic tag, and divides (modulo 2) by the generated polynomial equation G(x) to determine individual bits e₁˜eₖ of remainder (E(x)) (404).

As expressed by (Equation 5), Q(x) is expressed as a (n+m−1)th polynomial equation having as coefficients the individual bits of the received electronic tag data sₙ˜s₁ and the received reader data vₘ˜v₁.

$$\begin{matrix}Q ( x ) = {s}_{n} {x}^{n + m - 1} + {s}_{n - 1} {x}^{n + m - 2} + … + {s}_{3} {x}^{m + 2} + {s}_{2} {x}^{m + 1} + \\ {s}_{1} {x}^{m} + {v}_{m} {x}^{m - 1} + {v}_{m - 1} {x}^{m - 2} + … + {v}_{3} {x}^{2} + {v}_{2} x + {v}_{1} \\ = {\sum }_{i = 1}^{n} {s}_{i} {x}^{i - 1} \cdot {x}^{m} + {\sum }_{i = 1}^{m} {v}_{i} {x}^{i - 1} \\ = S ( x ) \cdot {x}^{m} + V ( x ) \\ = {q}_{n + m} {x}^{n + m - 1} + {q}_{n + m - 1} {x}^{n + m - 2} + … + {q}_{3} {x}^{2} + {q}_{2} x + {q}_{1} \\ = {\sum }_{i = 1}^{n + m} {q}_{i} {x}^{i - 1}\end{matrix} \qquad ( Equation 5 )$$

As expressed by (Equation 6), G(x) is expressed by a (c−1)th generated polynomial equation having as coefficients the generated polynomial equation data g_{c}˜g₁ stored in the memory. And, the generated polynomial equation is a factor of xⁿ⁻¹.

$$\begin{matrix}G ( x ) = {\sum }_{i = 1}^{c} {g}_{i} {x}^{i - 1} \\ = {g}_{c} {x}^{c - 1} + {g}_{c} {x}^{c - 2} + … + {g}_{3} {x}^{2} + {g}_{2} x + {g}_{1}\end{matrix} \qquad ( Equation 6 )$$

As expressed by (Equation 7), E(x) is expressed as a (k−1)th polynomial equation.

$$\begin{matrix}E ( x ) = \{ ( {s}_{n} {x}^{n + m - 1} + {s}_{n - 1} {x}^{n + m - 2} + … + {s}_{3} {x}^{m + 2} + {s}_{2} {x}^{m + 1} + \\ {s}_{1} {x}^{m} + {v}_{m} {x}^{m - 1} + {v}_{m - 1} {x}^{m - 2} + … + {v}_{3} {x}^{2} + {v}_{2} x + {v}_{1} ) \cdot \\ {x}^{c - 1} + {t}_{k} {x}^{k - 1} + {t}_{k} {x}^{k - 2} + … + {t}_{3} {x}^{2} + {t}_{2} x + {t}_{1} \} / G ( x ) \\ = \{ ( {\sum }_{i = 1}^{n + m} {s}_{i} {x}^{i - 1} \cdot {x}^{m} + {\sum }_{i = 1}^{m} {v}_{i} {x}^{i - 1} ) \cdot {x}^{c - 1} + {\sum }_{i = 1}^{k} {t}_{i} {x}^{i - 1} \} / G ( x ) \\ = \{ ( S ( x ) \cdot {x}^{m} + V ( x ) ) \cdot {x}^{c - 1} + T ( x ) \} / G ( x ) \\ = {\sum }_{i = 1}^{k} {e}_{i} {x}^{i - 1}\end{matrix} \qquad ( Equation 7 )$$

In a case where the error correction portion is realized by hardware, the generated polynomial equation data g_{c}˜g₁ might not be required to be stored in the memory.

Where all the individual bits eₖ˜e₁ of E(x) are 0, namely E(x) is 0, the control section judges that the electronic tag data and the CRC code have been transmitted without an error, namely, they are received correctly, and if even one of the individual bits e₁˜eₖ of E(x) is other than 0, namely, E(x) is other than 0, it judges that the read electronic tag data or CRC code has an error, namely, the received result has an abnormality (406, 407).

Where the received result is free from an abnormality, the read electronic tag data is transmitted to a server (408).

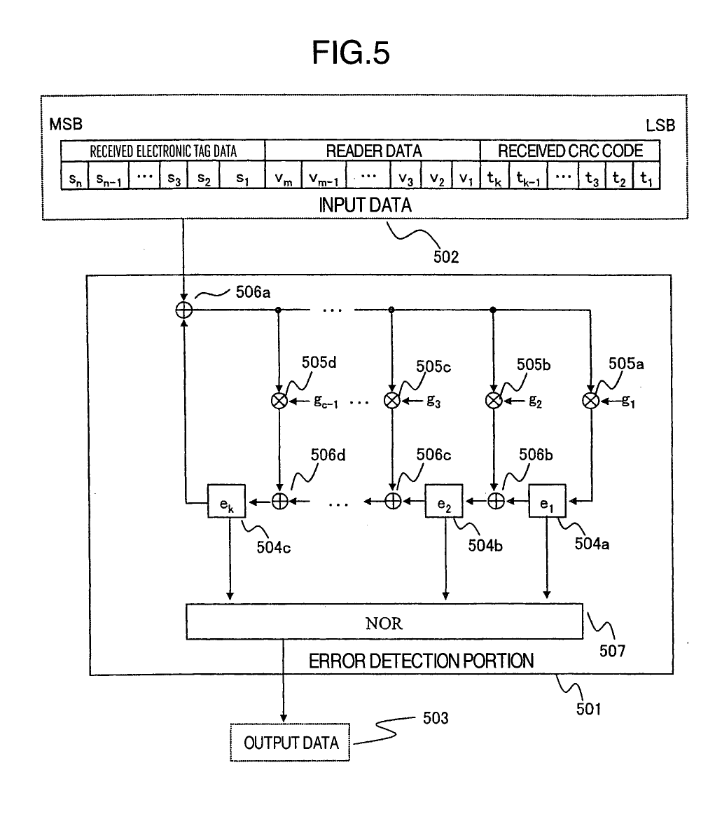

The above-described processes of (401)˜(408) can also be realized as programs executed by the control section. In this case, this program is stored as data in the memory of the control section. And, where the error detection portion for performing the processes of (404)˜(407) of FIG. 4 is implemented by hardware, it is expressed as shown in, for example, FIG. 5. An error detection portion (501) operates every unit time (clock). And, squares indicated by eᵢ (i=0, . . . , k) in the drawing indicate delay elements (registers) (504a˜c) of one unit time. And, the squares indicated by gᵢ are multipliers (505a˜d) which multiply the input by gᵢ and output (if gᵢ=0, wire connection itself is unnecessary, and if gᵢ=1, the multiplier is unnecessary and wire connection only). And, “+” indicates EXOR (exclusive OR) computing units (506a˜d). “NOR” indicates a NOR computing unit (507).

If there is no error after input data sₙ˜s₁ vₘ˜v₁ tₖ˜t₁ (502) which is comprised of the received electronic tag data, the reader data and the received CRC code have been entered sequentially from the most significant bit into the error detection portion at unit time intervals, E(x)=0, namely, all data eᵢ (i=0, . . . , k) of the individual registers become “0”. And, if there is an error, E(x)=0 is not established, so that it can be detected that the input data (502) has an error because output data (503) of the NOR computing unit is not 0. A conventionally known error detector for the error detection code can also be used other than the encoding portion shown in this embodiment.

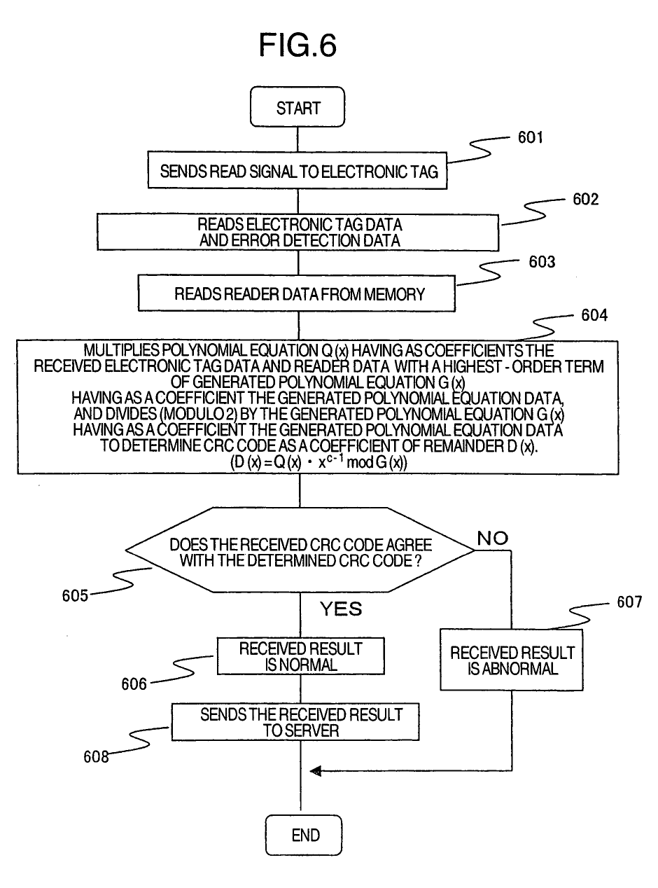

FIG. 6 shows a flow chart different from FIG. 4, indicating a process of reading electronic tag data from an electronic tag by the reader. Because processes of (601)˜(603) are similar to those of (401)˜(404) shown in FIG. 4, their descriptions are omitted.

The error detection portion in the control section of the reader multiplies polynomial equation Q(x) having as coefficients the individual bits of the received electronic tag data sₙ˜s₁, which are read from the electronic tag corresponding to the electronic tag data uₙ˜u₁ of the electronic tag, and the reader data vₘ˜v₁ with the highest-order term x^{c-1} of the generated polynomial equation G(x) having as coefficients the individual bits of the generated polynomial equation data, multiplies the highest-order term x^{c-1} of the generated polynomial equation G(x) having as coefficients the individual bits of the generated polynomial equation data, and divides (modulo 2) by the generated polynomial equation G(x) to determine individual bits d₁˜dₖ of a coefficient of remainder D(x) (604).

Q(x) and the generated polynomial equation G(x) are as shown in Equation (5) and Equation (6) described above.

D(x) is expressed as a k-th polynomial equation as indicated by (Equation 8) below.

$$\begin{matrix}D ( x ) = \frac{Q ( x ) \cdot {x}^{c - 1}}{G ( x )} \\ = {\sum }_{i = 1}^{k} {d}_{i} {x}^{i - 1} \\ = {d}_{k} {x}^{k - 1} + {d}_{k - 1} {x}^{k - 2} + … + {d}_{3} {x}^{2} + {d}_{2} x + {r}_{1}\end{matrix} \qquad ( Equation 8 )$$

If the CRC codes rₖ˜r₁ agree with coefficients dₖ˜d₁ of D(x), the error correction portion of the control section judges that the electronic tag data and the CRC code have been transmitted without an error, namely they have been received correctly, but if they do not agree, it judges that the read electronic tag data or the CRC code has an error, namely, the received result has an abnormality (606, 607).

If the received result does not have an abnormality, the read electronic tag data is transmitted to the server (608).

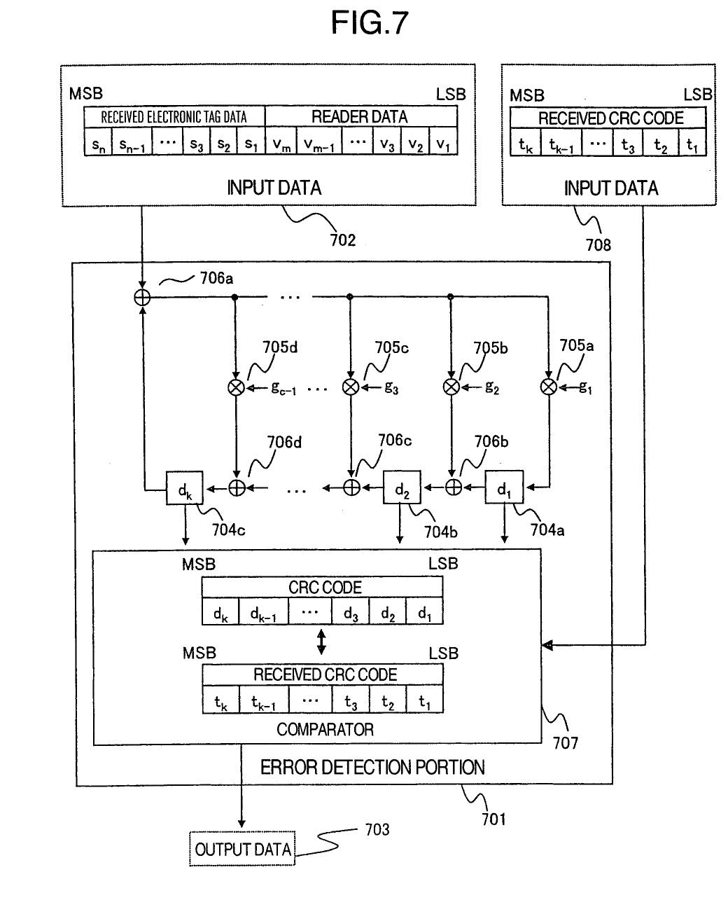

The above-described processes of (601)˜(608) can also be realized as a program executed by the control section. In this case, this program is stored as data in the memory of the control section. And, where the error detection portion for performing the processes of (604)˜(607) of FIG. 6 is implemented by hardware, it is expressed as shown in, for example, FIG. 7. An error detection portion (701) operates at unit time intervals (clock). And, squares indicated by dᵢ (i=0, . . . , k) in the drawing indicate delay elements (registers) (704a˜c) of one unit time. And, squares indicated by gᵢ are multipliers (705a-d) which multiply the input by gᵢ and output (if gᵢ=0, wire connection itself is unnecessary, and if gᵢ=1, the multiplier is unnecessary and wire connection only). And, “+” indicates EXOR (exclusive OR) computing units (706a-d). “NOR” indicates a NOR computing unit (707).

After input data sₙ˜s₁ vₘ˜v₁ (702) which are comprised of the received electronic tag data, the reader data and the received CRC code have been entered sequentially from the most significant bit into the error detection portion at unit time intervals, data dᵢ (i=0, . . . , k) and the received CRC codes tᵢ (i=0, . . . , k) of the individual registers are compared by a comparator (707). If there is no error, all the data d and the received CRC codes tᵢ (i=0, . . . , k) agree completely, but if there is an error, at least one of the data dᵢ and the received CRC code tᵢ (i=o, . . . , k) does not agree, and output data (703) of the comparator (707) is not 0. Thus, it can be judged that the input data (502) has an error. A conventionally known error detector for the error detection code can also be used other than the encoding portion shown in this embodiment.

If the received result has an abnormality, there may be the following cases (1) and (2).

(1) The electronic tag data and CRC code received from an electronic tag have an error.

(2) The CRC code stored in an electronic tag to be read is not generated from the reader data stored in a reader.

And, (1) and (2) might occur simultaneously.

If the received result has an abnormality, the electronic tag data and the CRC code can be reread from the electronic tag. In the case (1) that the received electronic tag data and CRC code have an error, the electronic tag data and CRC code free from an error can be read by rereading. In the case (2) that the CRC code is not generated from the reader data stored in the reader, it is judged that the received result has an abnormality no matter whatever times rereading is performed.

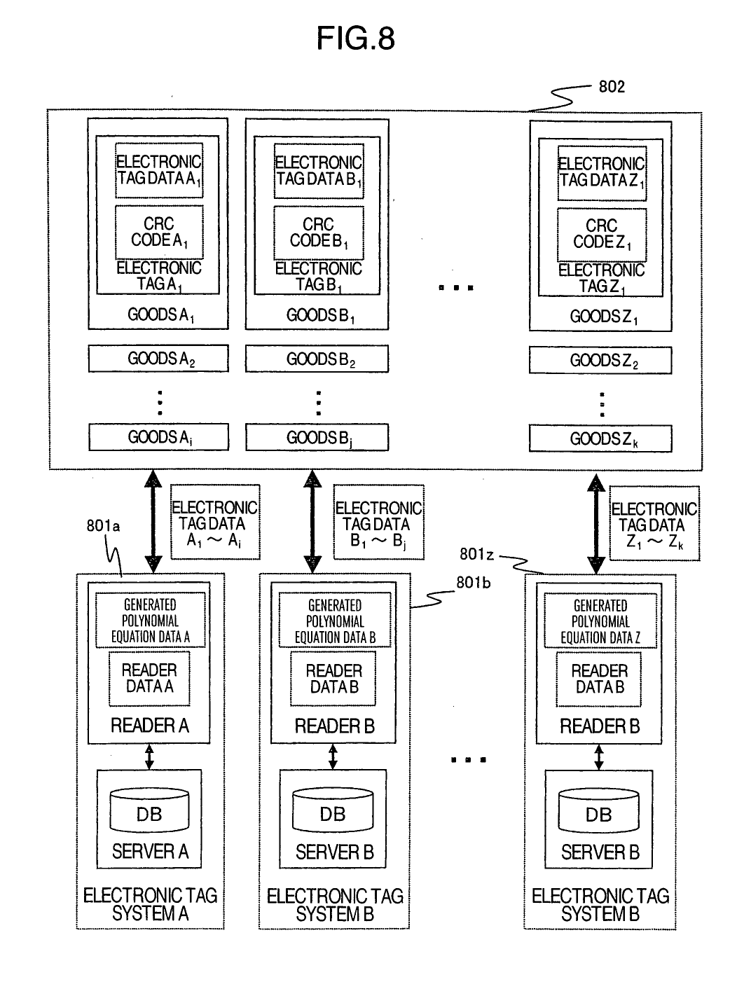

FIG. 8 shows a case that there are electronic tag systems each having a reader which stors different reader data.

Electronic tag A˜Z systems (801a˜801z) correspond to the electronic tag system of FIG. 1. The electronic tag A˜Z systems have readers A˜Z (hereinafter, A˜Z are arbitrary different numbers) storing reader data A˜Z which are different from one another.

Goods A₁˜Aᵢ, goods B₁˜Bⱼ, . . . , goods Zₗ˜Zₖ are placed at a prescribed place (802) (hereinafter, i, j, . . . , k are arbitrary different numbers). For example, in a case where the electronic tags are used for manufacturing management, the goods are products, and the place is a factory, in a case where the electronic tags are used for distribution management, the goods are products and the place is a shop, and in a case where the electronic tags are used for physical distribution management, the goods might be door-to-door delivery packages or airway luggage.

To the goods A₁˜Aᵢ, goods B₁˜Bⱼ, . . . , goods Z₁˜Zₖ are attached electronic tags A electronic tags B₁˜Bⱼ, . . . , electronic tags Z₁˜Zₖ.

The electronic tags A₁˜Aᵢ, electronic tags B₁˜Bᵢ, . . . , electronic tags Z₁˜Zₖ each store electronic tag data A₁˜Aᵢ and CRC codes A₁˜Aᵢ, electronic tags B₁˜Bⱼ and CRC codes B₁˜Bⱼ, . . . , electronic tags Z₁˜Zₖ and CRC codes Z₁˜Zₖ.

The CRC codes A₁˜Aᵢ, CRC codes B₁˜Bⱼ, . . . , CRC codes Z₁˜Zₖ each are generated from data having the concatenation of the electronic tag data A₁˜Aᵢ and reader data A, data having the concatenation of the electronic tag data B₁˜Bⱼ and reader data B, . . . , data having the concatenation of the electronic tag data Z₁˜Zₖ and reader data B.

Therefore, when the readers A, B, . . . , Z read the electronic tags A₁˜AᵢB₁˜Bⱼ . . . Z₁˜Zₖ which are attached to the goods A₁˜AᵢB₁˜Bⱼ . . . Z₁˜Zₖ respectively, they normally receive electronic tag data of the electronic tags A₁˜Aᵢ, electronic tag data of the electronic tags B₁˜Bⱼ, and electronic tag data of the electronic tags Z₁˜Zₖ. The readers A, B, . . . , Z judge about electronic tag data other than the electronic tag data of the electronic tags A₁˜Aᵢ, the electronic tag data of the electronic tags B₁˜Bⱼ, . . . , the electronic tag data of the electronic tags Z₁˜Zₖ that the received results have an abnormality.

Thus, only a particular reader having reader data used for generation of the CRC code stored in the electronic tag can selectively read the electronic tag data of the electronic tag according to the reading processes shown in FIG. 4 and FIG. 6.

And, the error detection of the electronic tag data and the selection of the electronic tag data associated with the reader data can be performed by single processing. It is not necessary to perform separately the error detection of the electronic tag data and the selection of the electronic tag data associated with the reader data, so that there are effects that computation time can be reduced when implemented by software in comparison with the case that they are performed separately and a circuit scale can be reduced when implemented by hardware.

Because the CRC code and the reader data of the particular reader are associated mutually, the electronic tag can be associated with the particular reader without newly providing the electronic tag data with an identifier or the like indicating a particular reader, namely without increasing a memory region and a circuit scale.

For example, in a case where the electronic tag systems A, B, . . . , Z are used by different business entities A, B, . . . , Z, and the electronic tags A₁˜Aᵢ are attached to products A₁˜Aᵢ of the business entity A, the reader A of the business entity A does not read the electronic tag data of the electronic tags attached to the products B₁˜Bⱼ, . . . , Z₁˜Zₖ of the other business entity B but can selectively read only the electronic tag data A₁˜Aᵢ of the electronic tags A₁˜Aᵢ attached to the products A₁˜Aᵢ of the business entity A. Thus, the reader A of the business entity A does not need to transmit the electronic tag data of the products B₁˜Bⱼ, . . . , Z₁˜Zₖ of the other business entities B, . . . , Z to the server A to check whether the electronic tag data B₁˜Bⱼ, . . . , Z₁˜Zₖ are of the products of the business entity A, so that communications traffic between the server A and the reader A can be reduced.

It can be made to read selectively an electronic tag having the CRC code generated from another reader data by changing the memory storing the reader data to a rewritable RAM or a nonvolatile memory and rewriting the reader data.

In the description of this embodiment, the quantity of the reader is one, but it is not exclusive, and plural readers having the same reader data can also be used in the respective electronic tag systems.

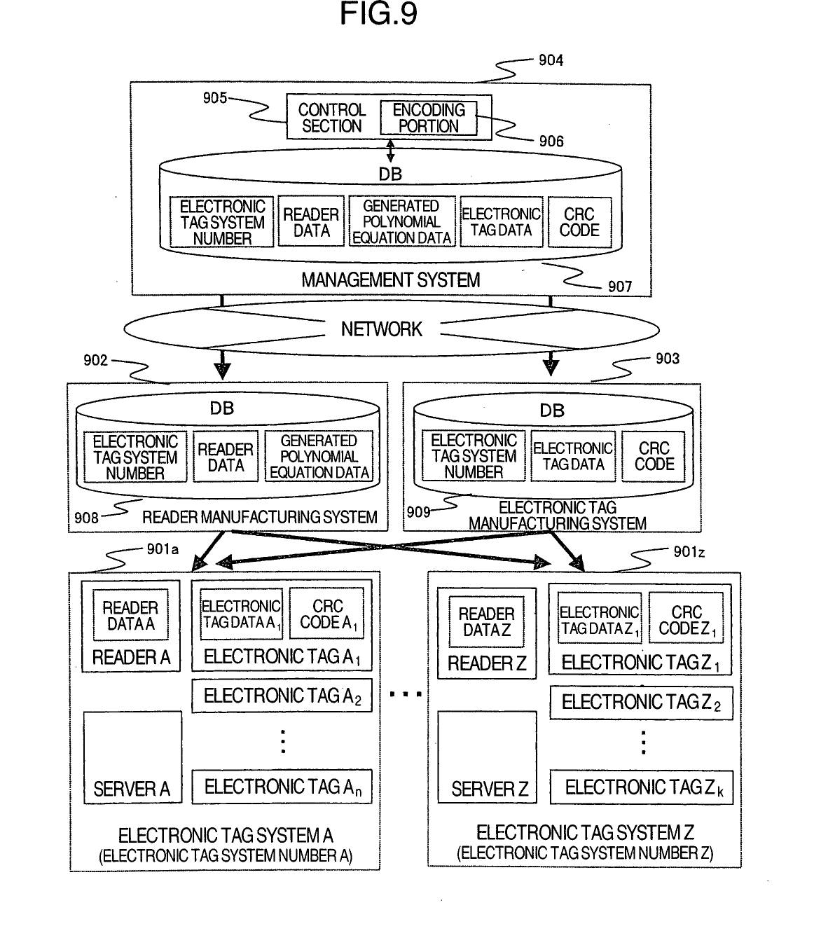

FIG. 9 shows a process of allocating electronic tag data and CRC codes to electronic tags, and reader numbers and generated polynomial equation data to readers.

A management system (904) has a database (907), which stores electronic tag system numbers, reader data, electronic tag data, CRC codes and generated polynomial equations, and a control section (905). The control section (905) has an encoding portion (906) which generates CRC codes.

A reader manufacturing system (902) for manufacturing readers has a database (908) for storing electronic tag system numbers, reader data, and generated polynomial equation data.

An electronic tag manufacturing system (903) for manufacturing electronic tags has a database (909) which stores electronic tag system numbers, electronic tag data, and CRC codes.

Electronic tag systems A˜Z (901a˜901z) correspond to the electronic tag system of FIG. 1.

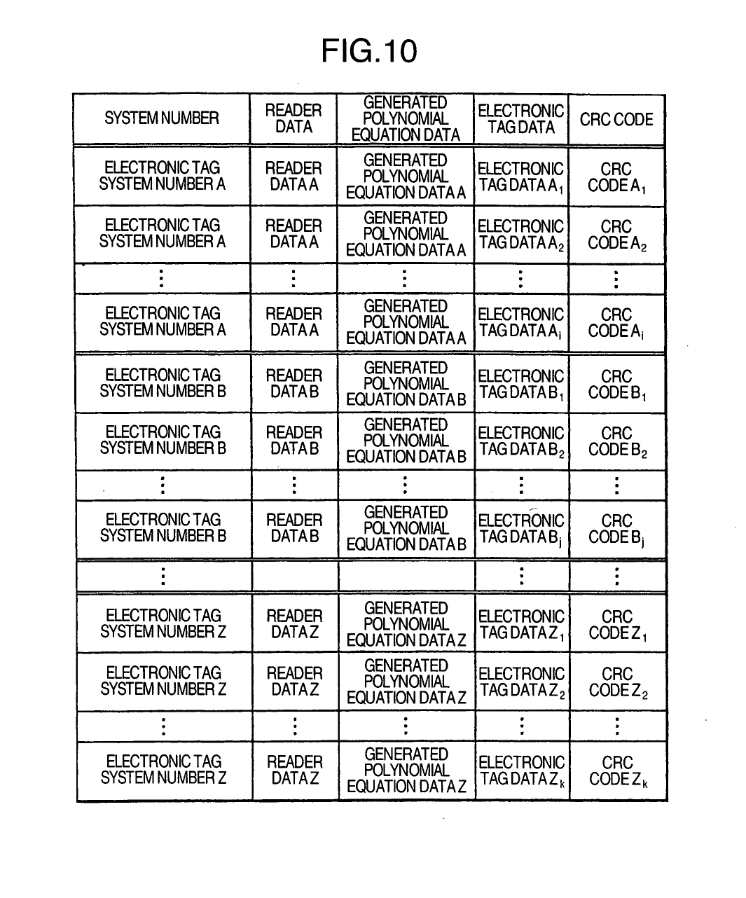

FIG. 10 shows a data structure stored in the management system. To the database are attached and stored electronic tag system numbers A˜Z in correspondence with the electronic tag systems A˜Z. And, reader data A and generated polynomial equation data A, reader data B and generated polynomial equation data B, . . . , reader data C and generated polynomial equation data C of the readers used for the electronic tag systems A, B, . . . , Z are stored in association with the electronic tag system numbers A, B, . . . , Z.

The control section of the management system generates electronic tag data A₁˜Aᵢ, electronic tag data B₁˜Bⱼ, . . . , electronic tag data Z₁˜Zₖ depending on the number of electronic tags used for the electronic tag systems A, B, . . . , Z. For example, the header of electronic tag data is determined to be a prescribed value, and service data can be random numbers, an ordinal number, and a combination of random numbers and an ordinal number. The electronic tag data A₁˜Aᵢ, electronic tag data B₁˜Bⱼ, . . . , electronic tag data Z₁˜Zₖ are stored in association with the electronic tag system numbers A, B, . . . , Z.

Besides, the control section of the management system generates CRC codes A₁, A₂, . . . , Aᵢ by the generated polynomial equation A from data having reader number A concatenated to the individual electronic tag data A₁, A₂, . . . , Aᵢ and stores them in association with the electronic tag data A₁, A₂, . . . , Aᵢ into the database. Similarly, CRC codes B₁, B₂, . . . , Bⱼ are generated and associated with the electronic tag data B₁, B₂, . . . , Bⱼ, . . . , CRC codes Z₁, Z₂, . . . , Zⱼ are generated and associated with the electronic tag data Z₁, Z₂, . . . , Zⱼ and they are stored in the database.

In other words, electronic tag system number X is associated with reader data X, CRC code X, electronic tag data X₁˜Xᵢ and CRC codes X₁˜Xᵢ and stored in the database (X and i denote an arbitrary number).

The electronic tag system numbers A˜Z, reader data A˜Z, and generated polynomial equation data A˜Z of the management system which are kept in the associated state are transmitted to and stored in the database of the electronic tag manufacturing system through a network.

The reader manufacturing system manufactures the readers A, B, . . . , Z, and the reader data A and generated polynomial equation data A, the reader data B and generated polynomial equation data B, . . . , the reader data Z and generated polynomial equation data Z are stored into the individual memories in the format shown in FIG. 3.

The readers A, B, . . . , Z manufactured by the reader manufacturing system are used in electronic tag user systems indicted by the reader system numbers A, B, . . . , Z with which the reader data and the generated polynomial equation data A, B, . . . , Z stored in them are associated.

The electronic tag system numbers A˜Z, the electronic tag data A₁Aᵢ, B₁˜Bⱼ, . . . , Z₁˜Zₖ and the CRC codes A₁˜Aᵢ, B₁˜Bⱼ, . . . , Z₁˜Zₖ of the management system which are kept in the associated state are transmitted to and stored in the database of the reader manufacturing system through a network.

The electronic tag manufacturing system manufactures electronic tags A₁, A₂, . . . , A₁, B₁, B₂, . . . , Bⱼ, . . . , Z₁, Z₂, . . . , Zₖ, and reader data A₁ and generated polynomial equation data A₁, reader data A₂ and generated polynomial equation data A₂, . . . , reader data Aᵢ and generated polynomial equation data Aᵢ, reader data B₁ and generated polynomial equation data B₁, reader data B₂ and generated polynomial equation data B₂, . . . , reader data Bⱼ and generated polynomial equation data Bⱼ, . . . , reader data Z₁ and generated polynomial equation data Z₁, reader data Z₂ and generated polynomial equation data Z₂, . . . , reader data Zₖ and generated polynomial equation data Zₖ are stored in the individual memories in the formats shown in FIG. 2.

The electronic tags A₁˜Aᵢ, B₁˜Bⱼ, . . . , Z₁˜Zₖ manufactured by the electronic tag manufacturing system are used in the electronic tag user systems A, B, . . . , Z indicated by the reader system numbers A, B, . . . , Z with which the electronic tag data and CRC code data A₁˜Aᵢ, B₁˜Bⱼ, . . . , Z₁˜Zₖ stored in the tags are associated.

In this embodiment, reader data, the generated polynomial equation data, electronic tag information and CRC codes are transmitted from the management system to the reader manufacturing system and the electronic tag manufacturing system through the network, but they may be stored in any storage medium and delivered.

And, an IC chip manufacturing system for manufacturing a memory for storing reader data and the generated polynomial equation data or an IC chip having that memory may be disposed independent of the reader manufacturing system to transmit the reader data and the generated polynomial equation data from the management system to the database possessed by the IC chip manufacturing system.

Similarly, an IC chip manufacturing system for manufacturing a memory for storing the electronic tag data and CRC codes or an IC hip having that memory may be disposed independent of the reader manufacturing system to transmit the electronic tag data and CRC codes from the management system to the database possessed by the IC chip manufacturing system.

Either the reader manufacturing system or the electronic tag manufacturing system or both of them may be provided with the functions of the management system to exchange information through the network.

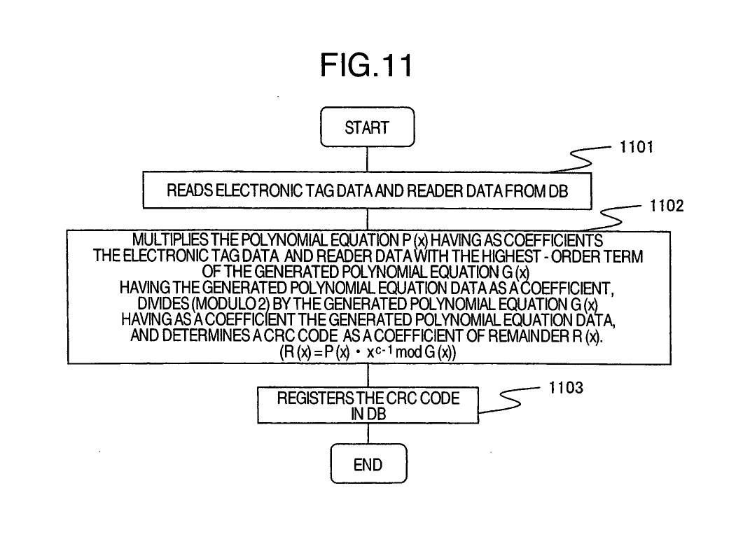

FIG. 11 shows a flow chart of the generation of a CRC code performed by the processing portion of the management system.

First, electronic tag data uₙ˜u₁ of n bits and reader data vₘ˜v₁ of m bits are read from the database (1101). Then, the encoding portion in the control section multiplies the polynomial equation Q(x) having as coefficients the individual bits of the electronic tag data uₙ˜u₁ and the reader data vₘ˜v₁ with the highest-order term x^{c-1} of the generated polynomial equation G(x) having the generated polynomial equation data as a coefficient, divides (modulo 0.2) by the generated polynomial equation G(x), and determines individual bits r₁˜rₖ of a coefficient of remainder R(x) as a CRC code (1102).

As indicated by (Equation 9), P(x) is expressed as a (n+m−1)th polynomial equation having as coefficients the individual bits of the electronic tag data uₙ˜uᵢ and reader data vₘ˜v₁.

$$\begin{matrix}P ( x ) = {u}_{n} {x}^{n + m - 1} + {u}_{n - 1} {x}^{n + m - 2} + … + {u}_{3} {x}^{m + 2} + {u}_{2} {x}^{m + 1} + \\ {u}_{1} {x}^{m} + {v}_{m} {x}^{m - 1} + {v}_{m - 1} {x}^{m - 2} + … + {v}_{3} {x}^{2} + {v}_{2} x + {v}_{1} \\ = {\sum }_{i = 1}^{n} {u}_{i} {x}^{i - 1} \cdot {x}^{m} + {\sum }_{i = 1}^{m} {v}_{i} {x}^{i - 1} \\ = U ( x ) \cdot {x}^{m} + V ( x ) \\ = {p}_{n + m} {x}^{n + m - 1} + {p}_{n + m - 1} {x}^{n + m - 2} + … + {p}_{3} {x}^{2} + {p}_{2} x + {p}_{1} \\ = {\sum }_{i = 1}^{n + m} {p}_{i} {x}^{i - 1}\end{matrix} \qquad ( Equation 9 )$$

In other words, P(x) has a concatenation of the most significant bit of the reader data vₘ˜v₁ with the least significant bit of the electronic tag data uₙ˜u₁ as the coefficients of the individual terms. And, the coefficients of highest-order to lowest-order terms of P(x) become to correspond in order of from the most significant bit to the least significant bit of the concatenated data uₙ˜u₁ vₘ˜v₁.

And, the generated polynomial equation G(x) is as expressed by Equation (6) above.

R(x) is expressed as a k-th polynomial equation as indicated by the following Equation (10).

$$\begin{matrix}R ( x ) = \frac{P ( x ) \cdot {x}^{c - 1}}{G ( x )} \\ = {\sum }_{i = 1}^{k} {r}_{i} {x}^{i - 1} \\ = {r}_{k} {x}^{k - 1} + {r}_{k} {x}^{k - 2} + … + {r}_{3} {x}^{2} + {r}_{2} x + {r}_{1}\end{matrix} \qquad ( Equation 10 )$$

Coefficients rₖ˜r₁ of the individual terms of the R(x) are registered as CRC codes in the database (1103).

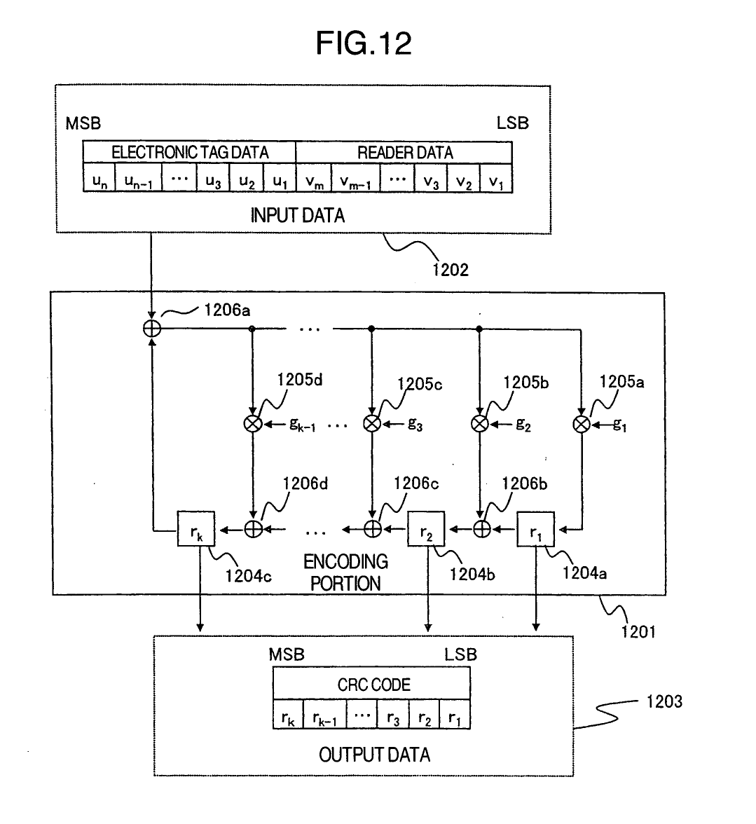

The above-described processes of (1101)˜(1103) can also be realized as a program executed by the control section of the management system. In this case, this program is stored as data in the memory of the control section. And, when the error detection portion for performing the process of (1102) of FIG. 6 is implemented by hardware, it becomes as shown in, for example, FIG. 12. This encoding portion (906) operates at unit time intervals (clock). And, squares indicated by rᵢ (i=0, . . . , k) in the drawing indicate delay elements (registers) (1204a˜c) of one unit time. And, squares indicated by gᵢ are multipliers (1205a˜d) which multiply the input by gᵢ and output (but, if gᵢ=0, wire connection itself is unnecessary, and if gᵢ=1, the multipliers are unnecessary, and wire connection only). And, “+” indicates EXOR (exclusive OR) computing units (706a˜d).

Data rᵢ (i=0, . . . , k) of the individual registers are determined as CRC codes when input data sₙ˜s₁ vₘ˜v₁ (1202) comprising electronic tag data and reader data have been entered sequentially from the most significant bit into the encoding portion at unit time intervals. A conventionally known encoder for an error detection code can also be used other than the encoding portion shown in this embodiment.

In this embodiment, the input data is determined as data arranged as uₙ˜u₁ vₘ˜v₁ from the most significant bit with electronic tag data and reader data concatenated in this order but, conversely may be data arranged as uₙ˜u₁ vₘ˜v₁ from the most significant bit having input data as concatenation of reader data and electronic tag data in this order. In this case, the input data to the error detection portions of FIG. 1, FIG. 5 and FIG. 7 must be arranged as the received electronic tag data and reader data.

The invention achieved by the present inventor was specifically described above with reference to the embodiments, but the invention is not limited to the above-described embodiments and various modifications may be made without deviating from the spirit and scope of the invention. For example, the CRC code may be determined from the electronic tag data and the reader data according to a particular algorithm. In this case, the error detection portions of FIG. 1, FIG. 5 and FIG. 7 must be complied with the particular algorithm.

The CRC code was used in this embodiment, but the CRC code is one of methods for checking the compliance of data, and the employment of another method for making compliance of data is not prohibited by the invention. For example, cyclic codes such as a hamming code, a CRC, a fire code, a BCH code and a Reed-Solomon code can be used. And, a method including provision of a code having an initial polynomial equation, which is to be generated according to the algorithm, generated by another method with electronic tag data and reader data determined as a matrix can be used. For example, a cryptographic algorithm according to a basic and simple method such as a parity check or a common key system using a key code of plural bits, or a cryptographic algorithm according to a public key system such as RSA or an elliptic curve cryptosystem can be adopted, and code generation by a hash function, error detection and correction code format can be adopted.

In the above description, the invention achieved by the present inventor was mainly described referring to the application to the electronic tag of the background field of technology, but it is not limited to it and can also be applied to other communications and the like.

### INDUSTRIAL APPLICABILITY

The present application can be applied to the electronic tag system.

1. An electronic tag for storing first information and an error detection code, wherein:
the electronic tag transmits the first information and the error detection code to a reader for storing second information, and
the error detection code is generated from the first information and the second information.

2. The electronic tag according to claim 1, wherein the error detection code is generated from third information which is concatenation of the first information and the second information.

3. The electronic tag according to claim 2, wherein:
individual bits of the error detection code are coefficients of a remainder obtained by multiplying a first polynomial equation having individual bits of the third information as coefficients with a leading coefficient of a third polynomial equation having individual bits of prescribed fourth information as coefficients, adding a second polynomial equation having individual bits of the second information as coefficients, and dividing by the third polynomial equation according to modulo 2.

4. An electronic tag for storing first information and a first error detection code, wherein:
the electronic tag transmits the first information and the first error detection code to a reader for storing second information, and
the first error detection code agrees with a second error detection code which is generated from the first information and the second information.

5. The electronic tag according to claim 4, wherein the first error detection code agrees with the second error detection code which is generated from third information which is concatenation of the first information and the second information.

6. The electronic tag according to claim 5, wherein:
the first information, the second information and the error correction code are in a relationship that all coefficients of individual terms of a remainder become zero when the remainder is obtained by multiplying a first polynomial equation having individual bits of the third information as coefficients with a leading coefficient of a third polynomial equation having individual bits of prescribed fourth information as coefficients, adding a second polynomial equation having individual bits of the second information as coefficients, and dividing by the third polynomial equation according to modulo 2.

7. The electronic tag according to claim 2, wherein the third information has the most significant bit of the second information concatenated the least significant bit of the first information.

8. The electronic tag according to claim 2, wherein the third information has the most significant bit of the first information concatenated the least significant bit of the second information.

9. The electronic tag according to claim 1, wherein the error correction code is a cyclic code.

10. A reader for receiving first information and an error detection code from an electronic tag for storing the first information and the error detection code, wherein:
the reader stores second information, and
the reader uses the second information and the error detection code to detect an error in the first information.

11. The reader according to claim 10, wherein the reader uses third information, which is concatenation of the first information and the second information, and the error detection code to detect an error in the first information.

12. The reader according to claim 11, wherein:
the reader judges whether the first information has an error by multiplying a first polynomial equation having individual bits of the third information as coefficients with a leading coefficient of a third polynomial equation having individual bits of prescribed fourth information as coefficients, adding a second polynomial equation having individual bits of the second information as coefficients, dividing by the third polynomial equation according to modulo 2, and judging whether all coefficients of individual terms of a remainder become zero.

13. The reader according to claim 11, wherein:
the reader judges whether the first information has an error by multiplying a first polynomial equation having individual bits of the third information as coefficients with a leading coefficient of a third polynomial equation having individual bits of prescribed fourth information as coefficients, and judging whether coefficients of individual terms of a remainder resulting from the division by the third polynomial equation according to modulo 2 agree with coefficients of individual terms of the error detection code.

14. A system having an electronic tag which stores first information and an error detection code, a reader which stores second information, and a server, wherein:
the electronic tag transmits the first information and the error detection code to the reader, and
the reader uses the second information and the error detection code to detect an error in the first information and transmits the first information which is free from an error to the server.

15. The system according to claim 14, wherein the reader uses third information, which is concatenation of the first information and the second information, and the error detection code to detect an error in the first information.

16. The system according to claim 15, wherein:
the reader judges whether the first information has an error by multiplying a first polynomial equation having individual bits of the third information as coefficients with a leading coefficient of a third polynomial equation having individual bits of prescribed fourth information as coefficients, adding a second polynomial equation having individual bits of the second information as coefficients, dividing by the third polynomial equation according to modulo 2, and judging whether coefficients of individual terms of a remainder become zero.

17. The system according to claim 16, wherein:
the reader judges whether the first information has an error by multiplying a first polynomial equation having individual bits of the third information as coefficients with a leading coefficient of a third polynomial equation having individual bits of prescribed fourth information as coefficients, and judging whether coefficients of individual terms of a remainder resulting from the division by the third polynomial equation according to modulo 2 agree with coefficients of individual terms of the error detection code.
